(19) United States
(12) Patent Application Publication
(10) Pub. No.: US 2025/0132679 A1
(43) Pub. Date: Apr. 24, 2025

(54) Voltage Transient Controlling in Configurable Integrated Voltage Regulation Schemes

(71) Applicant: PowerLattice Technologies Inc., Camas, WA (US)

(72) Inventors: Gang Ren, Camas, WA (US); Peng Zou, Camas, WA (US); Sujith S. Dermal, Chandler, AZ (US)

(21) Appl. No.: 18/981,342

(22) Filed: Dec. 13, 2024

Related U.S. Application Data
(63) Continuation-in-part of application No. 18/919,345, filed on Oct. 17, 2024.
(60) Provisional application No. 63/592,109, filed on Oct. 20, 2023.
(60) Provisional application No. 63/611,063, filed on Dec. 15, 2023.

(51) Int. Cl. H02M 3/158; H02M 1/00

(52) U.S. Cl. CPC H02M 3/158; H02M 1/0016

(57) ABSTRACT

This application is directed to a dual-loop control scheme including multiple voltage regulation loops configured to stabilize an output voltage. The voltage regulation loops include a first loop and a second loop. The first loop includes a feedback signal sensing component for sensing the output voltage. The first loop includes an error amplifier component for determining a voltage difference between the output voltage fed to the error amplifier component and a reference voltage. The first loop further includes a loop compensation network for generating a voltage compensation signal. The voltage regulations loops include a second loop for stabilizing output voltage after the transient voltage conditions have been compensated for by the first loop. The second loop includes a transition sensor module for detecting a transient voltage in the first loop's output voltage. And the second loop includes an amplification module for generating a regulation-based-adjustment signal.

### RELATED APPLICATION

This application claims benefit of U.S. Provisional Patent Application No. 63/611,063, titled “PMIC Voltage Regulator Control Scheme with Nested Fast Voltage Transient Suppression Loop,” filed Dec. 15, 2023, which is incorporated by reference in its entirety.

This application is a continuation-in-part of, and claims priority to, U.S. patent application Ser. No. 18/919,345, titled “Apparatus of Configurable PMIC with Array of Micro Integrated Voltage regulator cells and Shared Programmable References,” filed Oct. 17, 2024, which claims benefit of U.S. Provisional Patent Application No. 63/592,109, titled “Apparatus of Configurable PMIC with Array of Micro Integrated Voltage regulator cells and Shared Programmable References,” filed Oct. 20, 2023. Each of these patent applications is incorporated by reference in its entirety.

This application also relates to International Patent Application No. PCT/US24/52093, titled “Apparatus of Configurable PMIC with Array of Micro Integrated Voltage regulator cells and Shared Programmable References,” filed Oct. 17, 2024, which is incorporated by reference in its entirety.

### TECHNICAL FIELD

This application relates generally to power management of an electronic system, including, but not limited to, methods, systems, devices, and integrated circuits for voltage regulation in power management integrated circuit (PMIC).

### BACKGROUND

A system on a chip, also referred to as a system-on-chip (SoC), consolidates multiple components of a computer, such as a processor, memory, input/output interfaces, and various peripherals, on a substrate. SoCs are widely used in modern electronics, including smartphones, tablets, and embedded systems, where space, power efficiency, and performance are critical. To manage complex power requirements of these components, a Power Management Integrated Circuit (PMIC) is employed. The PMIC is responsible for regulating, distributing, and controlling the power delivered to the SoC's various subsystems. It efficiently manages multiple voltage levels, enabling features like dynamic voltage scaling to conserve energy and ensure the SoC operates within its optimal power and thermal limits. Together, the SoC and PMIC form a highly efficient system capable of handling diverse tasks with minimal power consumption, making them essential in today's compact, high-performance devices. However, the PMIC applied with the SoC may face some issues with consistency among different power rails and stability within a single power rail. Consistency issues arise when different power rails fail to deliver uniform voltage levels or fail to sequence properly, leading to performance variations or even malfunctions in the SoC. This can be caused by mismatched or unacceptably slow responding regulation circuitry, differing load demands, or poor coordination between multiple power rails. Stability issues, on the other hand, affect individual power rails where voltage fluctuations, oscillations, or noise occur within a single rail.

Modern processors (e.g., central processing units (CPUs), graphics processing units (GPUs)) can experience very fast dynamic transient currents far beyond the coverage of a PMIC voltage regulator's bandwidth. Rail voltages provided by the power rails of a processor can fluctuate greatly with large undershoots or overshoots. This can lead to processor malfunctions, which are often mitigated by incorporating voltage guard bands to stabilize supply voltages at the expense of increased chip area and reduced cost efficiency.

### SUMMARY

In accordance with at least some implementations disclosed herein is at least the realization that an SoC requires consistent and reliable power delivery on its power rails, particularly when the power rails experience dynamic transient currents. Each power rail delivers its rail voltage consistently, and different power rails providing the same rail voltage may need to be consistent with one another. Various implementations of this application are directed to methods, systems, devices, and integrated circuits for improving regulation of circuit fluctuations of a configurable power management integrated circuit (PMIC), including fluctuations caused by transient voltage variations introduced by voltage regulation schemes. In some implementations, the configurable PMIC includes a first loop configured to regulate voltage fluctuations during changes in rail voltage, and a second loop configured to suppress transient voltage variations caused by voltage adjustments implemented by the first loop. The second loop improves a response speed of voltage regulator circuits in case of transient voltage fluctuation caused by fast dynamic load current changes, and reduces a magnitude of the transient voltage fluctuations. In some implementations, a combination of the first loop and the second loop enhances power consumption performance of the PMICs and allows the PMIC to operate with no or smaller voltage guard bands.

In one aspect, an electronic system includes a plurality of voltage regulation loops configured to stabilize an output voltage of an electronic circuit. The plurality of voltage regulation loops includes a first loop configured to regulate the output voltage within the electronic circuit during transient voltage conditions. The first loop includes a feedback signal sensing component configured to sense the output voltage of the electronic circuit. The first loop further comprises an error amplifier component configured to determine a voltage difference between the output voltage and a reference voltage. The output voltage is fed to the error amplifier component by the feedback signal sensing component. And the first loop further comprises a loop compensation network configured to cause generation of a voltage compensation signal based on the voltage difference determined by the error amplifier component.

In another aspect, a PMIC includes a plurality of voltage regulation loops configured to stabilize an output voltage. The plurality of voltage regulation loops includes a first loop configured to regulate the output voltage within the electronic circuit during transient voltage conditions. The first loop includes a feedback signal sensing component configured to sense the output voltage of the electronic circuit. The first loop further comprises an error amplifier component configured to determine a voltage difference between the output voltage and a reference voltage. The output voltage is fed to the error amplifier component by the feedback signal sensing component. And the first loop further comprises a loop compensation network configured to cause generation of a voltage compensation signal based on the voltage difference determined by the error amplifier component.

In yet another aspect, a method is implemented to stabilize an output voltage. The method is performed at a PMIC having a plurality of voltage regulation loops, including a first loop comprising a feedback signal sensing component, an error amplifier component, and a loop compensation component, and a second loop that includes a transition sensor module and an amplification module. The method includes sensing, via the feedback signal sensing component, the output voltage of an electronic circuit in electronic communication with the PMIC. The method includes determining, via the error amplifier component, a voltage difference between the output voltage fed to the error amplifier component by the feedback signal sensing component, and a reference voltage. The method includes causing generation of a voltage compensation signal based on the voltage difference determined by the error amplifier component. The method includes, after generating the voltage compensation signal, detecting a voltage transient in an/the output voltage of the first loop the output voltage of the first loop, and generating a regulation-based-adjustment signal based on an output signal from the transition sensor module.

These illustrative implementations and implementations are mentioned not to limit or define the disclosure, but to provide examples to aid understanding thereof. Additional implementations are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example electronic system, in accordance with some implementations.

FIGS. 2A and 2B are a top perspective view and a bottom perspective view of an example electronic system including an SoC, in accordance with some implementations, respectively.

FIGS. 3A and 3B are a top perspective view and a bottom perspective view of another example electronic system, in accordance with some implementations, respectively.

FIG. 4A is a high-level block diagram of an example PMIC module, in accordance with some implementations, and FIG. 4B is a detailed block diagram of an example PMIC module, in accordance with some implementations.

FIG. 5 is a schematic diagram of an example voltage regulator cell, in accordance with some implementations.

FIG. 6 is a conceptual diagram illustrating example two voltage regulator cells (also shown in FIG. 4B) for providing a rail voltage V_{RAIL}, in accordance with some implementations.

FIG. 7A is a perspective view of an example PMIC chip including a plurality of inductors coupled in a plurality of voltage regulator cells, in accordance with some implementations.

FIGS. 7B and 7C are two cross sectional views of a portion of the PMIC chip shown in FIG. 7A including two inductors of two voltage regulator cells, in accordance with some implementations.

FIG. 8 is a flow diagram of an example method for stabilizing an output voltage, in accordance with some implementations.

Like reference numerals refer to corresponding parts throughout the several views of the drawings.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

In accordance with at least some implementations disclosed herein is the realization that an SoC requires consistent and reliable power delivery on its power rails. Each power rail delivers its rail voltage consistently, and different power rails providing the same rail voltage may need to be consistent with one another. Various implementations of this application are directed to methods, systems, devices, and integrated circuits for generating one or more rail voltages to power a plurality of power rails using a configurable PMIC that applies one or more consolidated reference circuits. The configurable PMIC includes an array of micro-integrated voltage regulator cells. A subset of voltage regulator cells may be selected and grouped to function as a power supply driving a power rail. The selected voltage regulator cells are driven by the same reference circuit In some implementations, the voltage regulator cells of the PMIC are grouped to form a plurality of power supplies, e.g., each of which outputs a programmable rail voltage, and a subset of voltage regulator cells corresponding to each respective power supply is driven by a respective common reference circuit.

In accordance with at least some implementations disclosed herein is the realization that a challenge of grouping a set of voltage regulator cells is load current balancing (or sharing) among the voltage regulator cells when each voltage regulator cell has a respective regulation control loop. Stated another way, two voltage regulator cells provide different output voltages and experience a load current imbalance, potentially causing a power rail coupled to these two voltage regulator cells to malfunction and permanently damage electronic components powered by the power rail.

To overcome this issue, a reference circuit is shared among a set of voltage regulator cells coupled to the same power rail. An output voltage of each voltage regulator cell tracks a respective reference voltage provided by the shared reference circuit. In some implementations, a digital-to-analog converter (DAC) provides a reference voltage that may drift based on different factors (e.g., locations, manufacturing conditions), even when the DAC is programmed using fixed digital input data. When the DAC is applied within a reference voltage source driving multiple voltage regulator cells coupled to the same power rail, the reference voltage drift jointly for the voltage regulator cells coupled to the same power rail, thereby making these voltage regulator cells perform consistently and stay in balance with one another. In some implementations, an array of DACs is coupled to a reference voltage distribution bus and a switch array, and configured to provide a common voltage reference to a set of voltage regulator cells that output the same rail voltage. Each voltage regulator cell does not have its self-contained DAC, thereby eliminating a current imbalance issue due to differences among self-contained DACs.

In accordance with some implementations, a dual-loop control scheme is implemented and includes both a main loop (also called a first loop) and a nested fast loop (also called a second loop). The second loop is supplemental to the first loop and applied to improve a transient response of a voltage regulator cell, while the first loop acts as a backbone of the voltage regulator cell to generate a rail voltage driving a power rail.

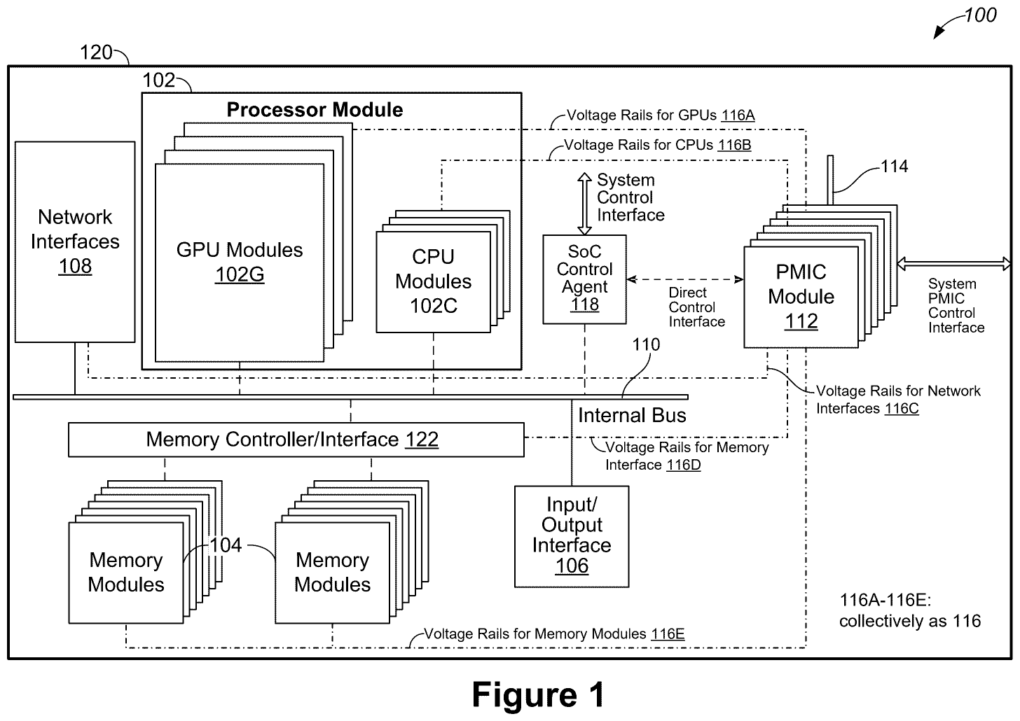

FIG. 1 is a block diagram of an example electronic system 100, in accordance with some implementations. The electronic system 100 includes at least a processor module 102, memory modules 104, an input/output (I/O) interface 106, one or more communication interfaces such as network interfaces 108, and one or more communication buses 110 for interconnecting these components. In some implementations, the I/O interface 106 allows the processor module 102 to communicate with an I/O device (e.g., a keyboard, a mouse or a trackpad). The I/O interface 106 may comply with a data communication bus standard including, but not limited to, universal serial bus (USB) and peripheral component interconnect express (PCIe). In some implementations, the communication bus(es) 110 include circuitry (sometimes called a chipset) that interconnects and controls communications among various system components included in electronic system 100. In some implementations, the electronic system 100 further includes other specialized hardware (e.g., wireless radios, graphics card, sound card, sensors).

In some implementations, the electronic system 100 further includes a PMIC module 112 configured to receive an input supply voltage 114. The PMIC module 112 is configured to modulate the received input supply voltage 114 to desired DC voltage levels (e.g., 5 V, 3.3 V, 1.8 V), as required by various components or circuits (e.g., the processor module 102) within the electronic system 100. For example, the PMIC module 112 is configured to generate the DC voltage levels at a plurality of power rails 116 for providing power to other components (e.g. components 102-110) in the electronic system 100. Examples of the plurality of power rails 116 include, but are not limited to: one or more GPU power rails 116A, one or more CPU power rails 116B, one or more networking power rails 116C, one or more memory interface power rails 116D, and one or more memory module power rails 116E. In some implementations, the PMIC module 112 further includes a layer within a printed circuit board (PCB) or an integrated circuit (IC), and the layer is applied as an input power plane for distributing the input supply voltage 114.

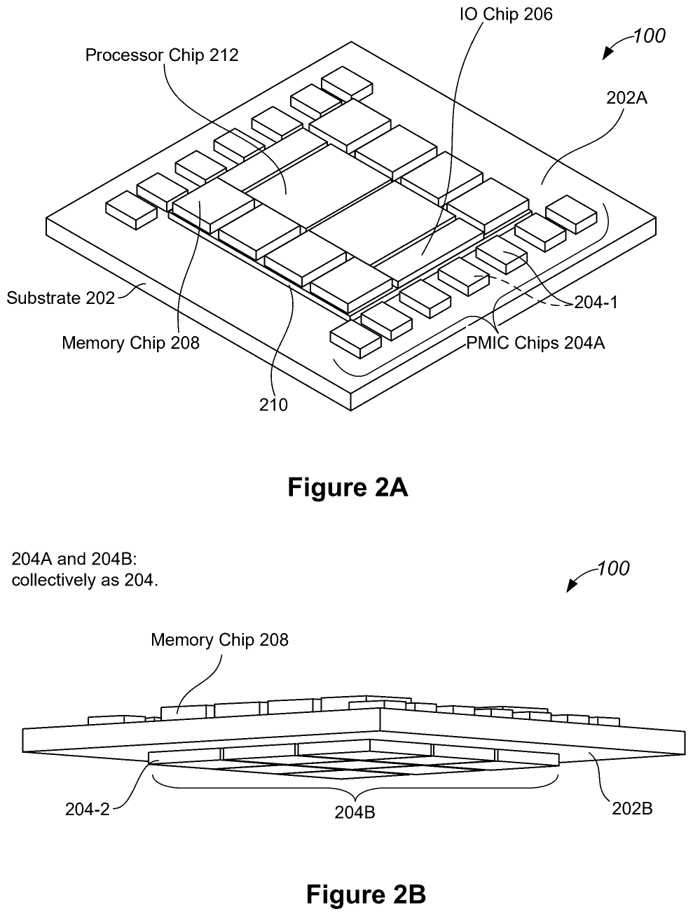

In some implementations, the electronic system 100 corresponds to an SoC 120. Different components of the electronic system 100 may be formed on two or more integrated circuits distributed on two or more chips, which are further assembled on a single substrate (e.g., substrate 202 in FIG. 2A) of the SoC 120. Alternatively, in some implementations, different components of the electronic system 100 are included in an integrated circuit formed on a single substrate of the SoC 120. In an example, the SoC 120 includes one of a silicon substrate, a polymeric substrate, a glass substrate, or a printed circuit board (PCB). Examples of the polymeric substrate include, but are not limited to, polyimide (PI), polyethylene terephthalate (PET), and polydimethylsiloxane (PDMS).

In some implementations, the SoC 120 further includes an SoC control agent 118 that refers to a control mechanism or module within the SoC 120. The SoC control agent 118 is configured to manage operation of different components (e.g., components 102-110) integrated on the SoC 120. More specifically, in some implementations, the SoC control agent 118 is configured to perform one or more of: resource management, inter-component communication, power management, task scheduling, security management, thermal management. For example, the SoC control agent 118 may allocate resources like power, processing time, and memory bandwidth to different components of the SoC 120; manages communication between various components, such as coordinating data transfers between the processor module 102 and peripherals; turn off or put certain components into a low-power state when they are not in use to conserve energy; manage scheduling of different tasks or operations across processing units of the processor module 102 within the SoC 120; implements security features (e.g., using hardware security modules, encryption, and access control); or monitor temperature sensors and adjusts operation (e.g., reducing clock speeds) to prevent overheating. In an example, the SoC control agent 118 includes one or more of: a power controller, a bus controller, and a clock controller. In some implementations, the SoC control agent 118 is implemented on a firmware level (e.g., adjusting system parameters dynamically based on workloads or external conditions).

In some implementations, the processor module 102 includes a plurality of processing units. In some implementations, the processor module 102 includes two or more different types of processing units including a subset of: one or more central processing units (CPUs) 102C, one or more graphics processing units (GPU) 102G, a digital signal processor (DSP), a neural processing unit (NPU) (also called artificial intelligence (AI) accelerator), an image signal processors (ISP), a video processing unit (VPU), an audio processing unit (APU), a secure microcontroller, and a field programmable gate array (FPGA). The CPUs 102C are configured to execute instructions from software (e.g., operating systems, applications). Examples of CPU architecture include, but are not limited to, reduced instruction set computing (RISC) and complex instruction set computing (CIS). The GPUs 102G are configured to render graphics and handle tasks that require parallel processing, such as image processing, video encoding/decoding, and machine learning.

In some implementations, the one or more of network interfaces 108 are configured to enable communication between the SoC 120 and external networks, such as local area networks (LANs) or the Internet, and includes both hardware and software components that handle data transmission, reception, and protocol management. The network interfaces 108 may include one or more interfaces for Wi-Fi, Ethernet, and Bluetooth networks, each allowing the electronic system 100 to exchange data with an external source, and participate in networked applications, such as IoT (Internet of Things), mobile communications, or cloud computing.

In some implementations, the memory modules 104 include high-speed random-access memory, such as static random-access memory (SRAM), double data rate (DDR) dynamic random-access memory (DRAM), or other random-access solid state memory devices. In some implementations, the memory modules 104 include non-volatile memory, such as one or more magnetic disk storage devices, optical disk storage devices, flash memory devices, or other non-volatile solid state storage devices. In some implementations, the memory modules 104, or alternatively the non-volatile memory device(s) within the memory modules 104, include a non-transitory computer readable storage medium. In an example, a memory module 104 includes a high bandwidth memory (HBM) configured to provide a data bandwidth greater than a bandwidth threshold to support GPUs 102G. The HBM includes a plurality of memory dies that are stacked vertically on top of each other. In some implementations, the electronic system 100 further includes a memory controller 122 coupled to manage memory access requests for the memory modules 104.

FIGS. 2A and 2B are a top perspective view and a bottom perspective view of an example electronic system 100, in accordance with some implementations, respectively. The electronic system 100 includes an SoC 120 having a substrate 202. The substrate 202 includes a first surface 202A and a second surface 202B that is opposite to the first surface 202A. The substrate 202 may be one of a silicon substrate, a polymeric substrate, a glass substrate, or a PCB. Examples of the polymeric substrate include, but are not limited to, PI, PET, and PDMS. In some implementations, each electronic component of the electronic system 100 corresponds to a region of the substrate 202, and includes a portion of an integrated circuit of the SoC 120. Alternatively, in some implementations, each electronic component of the electronic system 100 includes one or more chips that are mounted onto the substrate 202, e.g., with or without an intermediate support structure 210. In an example, the substrate 202 is made of a polymeric material, and the intermediate support structure 210 is made of silicon and applied to mechanically support a plurality of components (e.g., including an IO chip 206, a memory chip 208, a processor chip 212).

In some implementations not shown, all electronic components included in the electronic system 100 are disposed on the first surface 202A of the substrate 202. Alternatively, in some implementations, a first subset of electronic components of the electronic system 100 are disposed on the first substrate 202A of the substrate 202, and a second subset of electronic components of the electronic system 100 are disposed on the second substrate 202B of the substrate 202. In an example, one or more chips corresponding to a subset of the electronic components 102-108, 118, and 122 are disposed on the second surface 202B. In another example, one or more chips corresponding to the PMIC module 112 are disposed on the second surface 202B.

In some implementations, the PMIC module 112 includes a plurality of distinct PMIC chips 204, which further include a first set of PMIC chips 204A and a second set of PMIC chips 204B. The first set of PMIC chips 204A are disposed on the first surface 202A of the substrate 202, e.g., jointly with all or a subset of remainder components of the SoC 120 distinct form the PMIC module 112. The second set of PMIC chips 204B are disposed on the second surface 202B of the substrate 202. A rail voltage outputted by the first set of PMIC chips 204A is routed on or under the first surface 202A, e.g., by way of a configurable power plane, to access a power rail 116 of the remainder components of the SoC 120. In some implementations, a rail voltage is outputted by the second set of PMIC chips 204B and routed vertically across the substrate 202, from the second surface 202B to the first surface 202A, to access an associated power rail 116 located on or under the first surface 202A, e.g., by way of a configurable power plane.

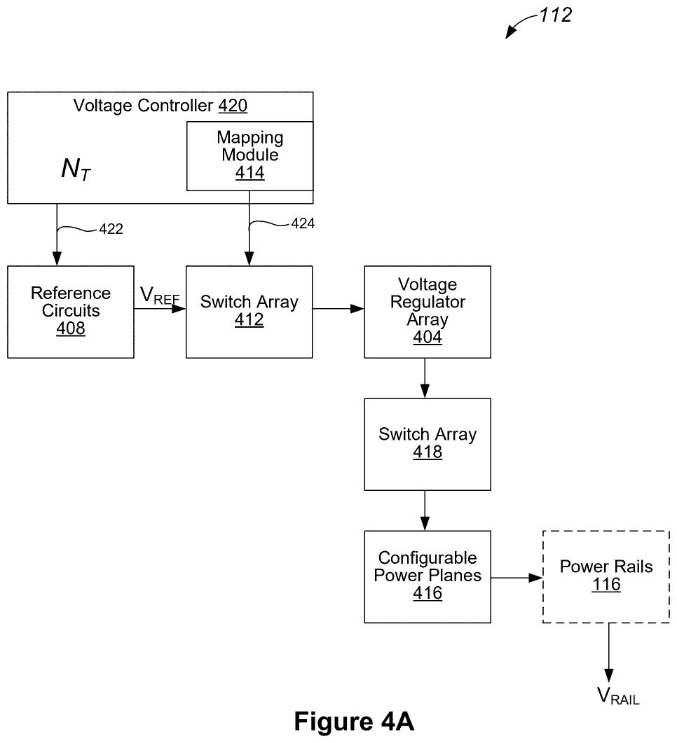

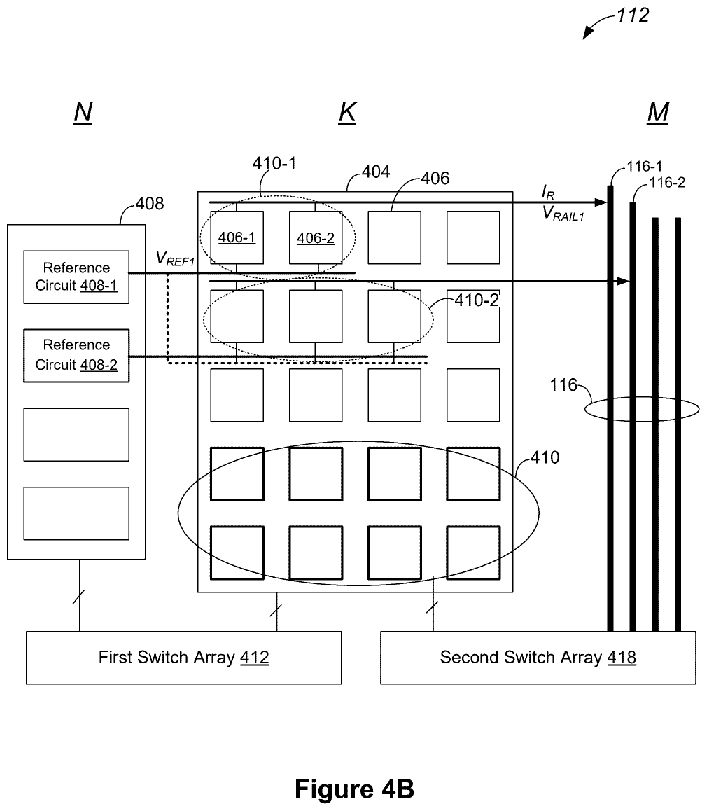

In some implementations, the PMIC module 112 includes a plurality of voltage regulator cells (e.g., voltage regulator cells 406 in FIG. 4B). In an example, a first PMIC chip 204-1 includes a subset of one or more respective voltage regulator cells (e.g., cell 406 in FIG. 4B), and is disposed immediately adjacent to an IO chip 206 including the I/O interface 106, allowing the I/O interface 106 to access a rail voltage provided by the subset of voltage regulator cells of the first PMIC chip 204-1. Alternatively, in some situations, two or more first PMIC chip 204-1 are disposed immediately adjacent to the IO chip 206 to provide the rail voltage to the IO chip 206 jointly. In another example, a memory chip 208 including one of the memory modules 104 is disposed on a location of the first surface 202A, and a second PMIC chip 204-2 is disposed a location of the second surface 202B aligned with (e.g., opposite to) the location of the first surface 202A. The second PMIC chip 204-2 includes a subset of one or more respective voltage regulator cells (e.g., cell 406 in FIG. 4B), and allows the one of the memory modules 104 to access a rail voltage provided by the respective voltage regulator cells vertically. By these means, a component of the SoC 120 may access its associated voltage regulator cell(s) located on a respective PMIC chip 204 that is disposed in proximity to the component without introducing an extended length to access a power rail 116, which helps reduce resistive and capacitive parasitics of the power rail 116 and enhance performance of the SoC 120.

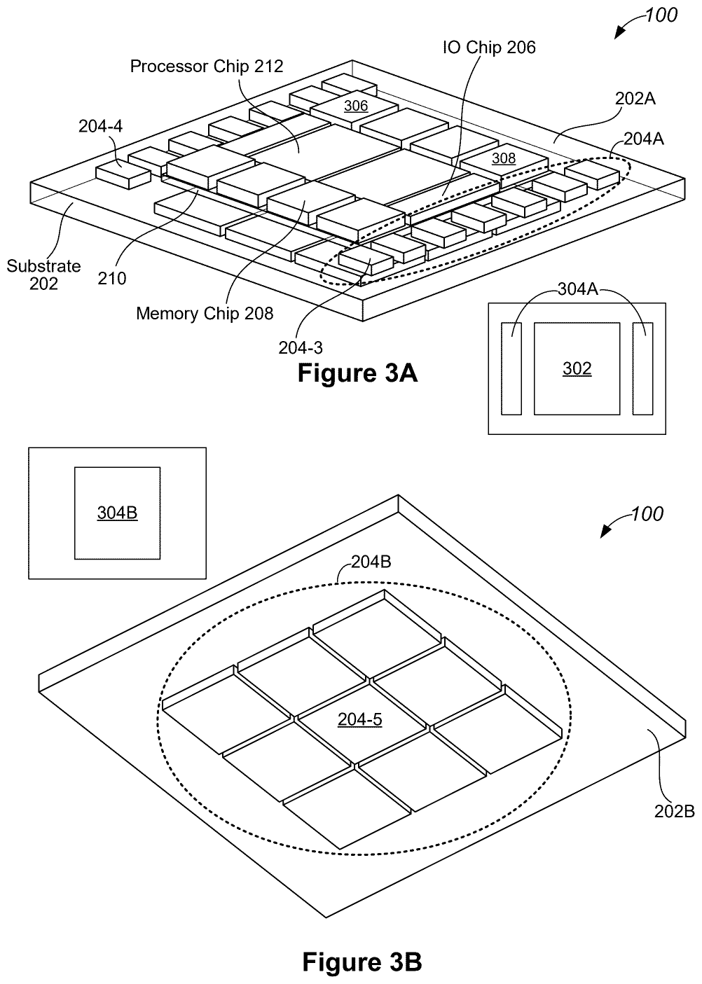

FIGS. 3A and 3B are a top perspective view and a bottom perspective view of another example electronic system 100, in accordance with some implementations, respectively. In some implementations, the first surface 202A of the substrate 202 includes a device region 302 on which a plurality of component chips (e.g., processor chip 212, IO chip 206, memory chips 208) are disposed. One or more first PMIC regions 304A (e.g., two PMIC regions) are located adjacent to the device region 302, and a first set of PMIC chips 204A are disposed on the one or more PMIC regions 304A of the first surface 202A of the substrate 202. For example, two rows of PMIC chips 204A are disposed adjacent to two opposing sides of the device region 302. In another example not shown, four rows of PMIC chips 204A are disposed adjacent to four distinct sides of the device region 302, respectively.

In some implementations not shown, the second surface 202B of the substrate 202 includes an alternative device region on which one or more component chips (e.g., processor chip 212, IO chip 206, memory chips 208) are disposed and one or more PMIC regions on which a second set of PMIC chips 204B are disposed, independently of a chip arrangement of the first surface 202A. Alternatively, in some implementations (FIG. 3B), the second surface 202B of the substrate 202 includes a second PMIC region 304B. Referring to FIG. 3A, the perspective view of the integrated electronic system 100 is depicted from the top angle with a see-through effect (e.g., to see through the substrate 202). In some implementations, the second PMIC region 304B at least partially overlaps the device region 302, allowing a component chip mounted on the device region 302 to access an output of the second PMIC region 304B using a via (e.g., a through silicon via (TSV)).

In some implementations, centers of the second PMIC region 304A and the device region 302 are aligned with one another, i.e., a center of the second PMIC region 304A and a center of the device region 302 are directly opposite to one another on two opposing surfaces 202A and 202B of the substrate 202. Further, in some implementations, sizes of the second PMIC region 304A and the device region 302 are equal to each other. Alternatively, in some implementations, the sizes of the second PMIC region 304A and the device region 302 are different from each other. Alternatively, in some implementations, the second PMIC region 304A and the device region 302 are independent from one another in size and/or in position.

In other words, the PMIC module 112 includes a plurality of voltage regulator cells distributed in a subset of the plurality of PMIC chips 204. Each PMIC chip 204 is located at a respective position on the first surface 202A or the second surface 202B of the substrate 202. In some implementations, one or more respective voltage regulator cells of the plurality of voltage regulator cells are grouped based on their locations to provide a plurality of rail voltages to a plurality of power rails 116 coupled to different components of the SoC 120. More specifically, in some implementations, each power rail 116 coupled to a component (e.g., CPU chip, GPU chip, memory chip, IO chip) is coupled to a set of voltage regulator cells, which are selected based on their locations with respect to a location of the component. For example, the set of voltage regulator cells are the closest to the respective component in distance compared with a remainder of the voltage regulator cells, thereby controlling associated resistive and capacitive parasitics. In another example, the set of voltage regulator cells, which coupled to the respective component, provides the lowest parasitic level. Among two voltage regulator cells having equal distances form the respective component, a voltage regulator cell located on the first surface 202A is selected over a voltage regulator cell located on the second surface 202B. In some implementations, a voltage regulator cell located on the first surface 202A and having a larger distance from the respective component is selected over a voltage regulator cell located on the second surface 202B and having a smaller distance from the respective component.

In some implementations, the PMIC module 112 further includes a plurality of reference circuits (e.g., circuit 408 in FIGS. 4A and 4B). The plurality of reference circuits may be formed on the same PMIC chip 204 or distributed on two or more PMIC chips 204. For example, each PMIC region 304A or 304B includes at least one PMIC chip 204 (e.g., chips 204-3, 204-4, and 204-5) dedicated to providing one or more reference circuits. In another example, all of the plurality of reference circuits used within the voltage regulator cells of the PMIC module 112 are consolidated on a single PMIC chip (e.g., chip 204-5).

Alternatively, in some implementations, the plurality of reference circuits used with the voltage regulator cells of the PMIC module 112 are provided by a single chip 306 or distributed among a plurality of chips (e.g., chips 306 and 308), which are mounted on, or integrated in, the device region 302.

FIG. 4A is a high-level block diagram of an example PMIC module 112, in accordance with some implementations, and FIG. 4B is a detailed block diagram of an example PMIC module 112, in accordance with some implementations. The PMIC module 112 includes, or is coupled to, a plurality of power rails 116 configured to provide one or more rail voltages V_{RAIL}. The PMIC module 112 further includes an array 404 of voltage regulator cells 406 and a plurality of reference circuits 408. The plurality of reference circuits 408 are coupled to, but distinct from, the array 404 of voltage regulator cells 406. The array 404 of voltage regulator cells 406 is coupled to the plurality of power rails 116, and configured to provide a plurality of voltage regulator sets 410. Each voltage regulator set 410 is configured to output a respective rail voltage V_{RAIL} to a respective power rail 116. Each of the plurality of reference circuits 408 is shared by, and configured to provide a respective reference voltage V_{REF} to, one or more respective voltage regulator cells 406 of a respective voltage regulator set 410. The respective voltage regulator set 410 is configured to generate the respective rail voltage V_{RAIL} based on the respective reference voltage V_{REF}.

Stated another way, some implementations of this application include a PMIC module 112 that has an array 404 of voltage regulator cells 406, a plurality of voltage references 408 that are selectable and programmable, and distribution circuits and buses that are selectable. Different numbers of voltage regulator cells 406 may be grouped together to form a voltage regulator set 410 for outputting a rail voltage V_{RAIL} (also called a power supply voltage). The array 404 of voltage regulator cells 406 may be grouped to form a single voltage regulator set 410 or a plurality of power regulator sets 410, thereby providing a single rail voltage V_{RAIL} or multiple rail voltages V_{RAIL}. In some implementations, the PMIC module 112 provides a plurality of rail voltages V_{RAIL} correspond to a plurality of distinct voltage regulator sets 410, and each voltage regulator set 410 includes a respective number of voltage regulator cells 406, independently of other voltage regulator set(s) 410. For each voltage regulator set 410, outputs of the respective voltage regulator cells 406 are electrically coupled (e.g., shortened) to one another and further to a respective power rail 116. In some implementations, a voltage regulator set 410 is configured to output a variable rail voltage V_{RAIL} (e.g., to track a respective reference voltage V_{REF}).

In some implementations, the PMIC module 112 includes, or is coupled to, a single substrate (e.g., substrate 202 in FIGS. 2A and 2B). The array 404 of voltage regulator cells 406 and the plurality of reference circuits 408 are disposed on the substrate 202, separately from one another. In some implementations, the array 404 of voltage regulator cells 406 and the plurality of reference circuits 408 correspond to different sets of PMIC chips 204 disposed on PMIC regions 304A and 304B (FIGS. 3A and 3B) of the substrate 202. Alternatively, in some implementations, the array 404 of voltage regulator cells 406 is distributed in PMIC chips 204 disposed on the PMIC regions 304A and 304B of the substrate 202, and the plurality of reference circuits 408 correspond to chips (e.g., chip 306 or 308 in FIG. 3A) disposed on a device region 302 (FIG. 3A) of the substrate 202.

Referring to FIG. 4B, in some implementations, the plurality of power rails 116 include a first number M of power rails 116, and the plurality of reference circuits 408 include a second number N of reference circuits 408. The second number N is equal to or less than the first number M. Further, in some implementations, each reference circuit 408 and a respective power rail 116 is uniquely associated with each other, and the respective reference circuit 408 is configured to provide the respective reference voltage V_{REF} to the respective voltage regulator cell set 410 assigned to generate the rail voltage V_{RAIL} for the power rail 116. A number of voltage regulator cells 406 in the respective voltage regulator cell set 410 may be varied.

In some implementations, rail voltages V_{RAIL} of two power rails 116-1 and 116-2 are equal to each other, and each power rail 116 maintains a consistent voltage. It is required that voltage regulator cells 406 contributing to each respective power rail 116-1 or 116-2 be driven by the same respective reference circuit 408. Further, in some implementations, two voltage regulator sets 410-1 and 410-2 corresponding to the two power rails 116-1 and 116-2 are coupled to two distinct reference circuits 408-1 and 408-2. Alternatively, in some implementations, each of the voltage regulator sets 410-1 and 410-2 corresponding to the two power rails 116-1 and 116-2 are coupled to the same reference circuit 408 (e.g., 408-1). As such, the second number N of the reference circuits 408 is equal to or less than the first number M of the power rails 116.

In some implementations, the plurality of power rails 116 include a first number M of power rails 116, and the plurality of reference circuits 408 include a second number N of reference circuits 408. The array 404 of voltage regulator cells 406 includes a third number K of voltage regulator cells 406. The second number N is equal to or less than (≤) the third number K, and the first number M is equal to or less than(≤) the third number K.

In some implementations, the PMIC module 112 includes a first switch array 412 (e.g., having the second number N of rows and the third number K of columns, or the second number N of columns and the third number K of rows). For example, rows of the first switch array 412 are electrically coupled to the second number N of reference circuits 408, and columns of the first switch array 412 are electrically coupled to the third number K of voltage regulator cells 406 of the array 404. Each row-column cross section of the first switch array 412 includes a switch component configured to control coupling of a respective reference circuit 408 and a respective voltage regulator cell 406. For each voltage regulator set 410 (e.g., set 410-1 in FIG. 4B), a respective set of switch components of the first switch array 412 are enabled to couple the respective reference circuit 408 (e.g., circuit 408-1) to the one or more respective voltage regulator cells 406 (e.g., cells 406-1 and 406-2). Note that, in some implementations, lines connecting the reference circuits 408-1 and 408-2 directly to the voltage regulator cells 406 in the voltage regulator sets 410-1 and 410-2 may not correspond to interconnects and are drawn in FIG. 4B merely for illustrative purposes.

Referring back to FIG. 4A, in some implementations, the PMIC module 112 further includes a mapping module 414 coupled to the first switch array 412. The mapping module 414 is configured to control the switch components of the first switch array 412 to group the voltage regulator cells 406 to form the plurality of voltage regulator sets 410. More specifically, the mapping module 414 is configured to determine whether to enable or disable each of the switch components of the first switch array 412.

In some implementations, the PMIC module 112 further includes a plurality of configurable power planes 416 embedded in a module substrate of the PMIC module 112 or a substrate 202 to which the PMIC module 112 is mounted. Each of the plurality of power rails 116 is electrically coupled to a respective power plane 416, and extends to one or more electrical components (e.g., modules 102-108) to provide a respective rail voltage V_{RAIL} to these components. Each output of voltage regulator cells 406 of a respective voltage regulator set 410 is also electrically coupled to the respective power plane 416, providing the power voltage V_{RAIL} to the respective power plane 416.

Further, referring to FIG. 4B, in some implementations, the PMIC module 112 includes a second switch array 418 (e.g., having the first number M of rows and the third number K of columns, or the first number M of columns and the third number K of rows). For example, rows of the first switch array 412 are electrically coupled to the first number M of power rails 116 or configurable power planes 416, and columns of the second switch array 418 are electrically coupled to outputs of the third number K of voltage regulator cells 406 of the array 404. Each row-column cross section of the second switch array 418 includes a switch component configured to control coupling a respective voltage regulator cell 406 to a respective configurable power plane 416 or to a respective power rail 116. For each voltage regulator set 410 (e.g., set 410-1 in FIG. 4B), a respective set of switch components of the first switch array 412 are enabled to couple the one or more respective voltage regulator cells 406 (e.g., cells 406-1 and 406-2) to the a respective configurable power plane 416 or to the respective power rail 116 (e.g., rail 116-1). Additionally, in some implementations, the second switch array 418 and the first switch array 412 are integrated in a single switch array.

Note that, in some implementations, lines connecting the power rails 116-1 and 116-2 directly to the voltage regulator cells 406 in the voltage regulator sets 410-1 and 410-2 may not correspond to interconnects and are drawn in FIG. 4B merely for illustrative purposes.

In some implementations, the plurality of voltage regulator sets 410 include a first voltage regulator set 410-1 that is configured to output a first rail voltage V_{RAIL1} (e.g., 1.2V, 0.8V) to a first power rail 116-1, and the first rail voltage is equal to a first reference voltage V_{REF1} provided by a first reference circuit 408-1. Stated another way, an output voltage of each voltage regulator set 410 is set by its associated reference voltage, and the voltage regulator set 410 is configured to track its associated reference voltage provided by a respective reference circuit 408.

Referring back to FIG. 4A, in some implementations, the PMIC module 112 further includes a voltage controller 420 coupled to the plurality of reference circuits 408. The voltage controller 420 is configured to generate a digital control signal 422 based on the first rail voltage associated with the first power rail 116-1 and provide the digital control signal 422 to the first reference circuit 408-1 defining the first reference voltage V_{REF1}. The first power rail 116-1 extends to one or more electrical components (e.g., modules 102-108) to provide the first rail voltage to these components. Characteristics of the first power rail 116-1 (e.g., rail current, rail voltage) are determined based on operation of the one or more electrical components. The first reference voltage of the first reference circuit 408-1 is further determined and set based on the characteristics of the first power rail 116-1. In some implementations, the plurality of reference circuits 408 are identical to one another. The digital control signal 422 determines magnitudes of the reference voltages V_{REF} outputted by the plurality of reference circuits 408. Conversely, in some implementations, at least two of the plurality of reference circuits 408 are different from one another. In an example, each reference circuit 408 includes a digital-to-analog converter (DAC).

Additionally, in some implementations, the first voltage regulator set 410-1 further includes a target number N_{T} (e.g., 2) of voltage regulator cells 406 and is configured to deliver up to a predefined rail current I_{RAIL} to the first power rail 116-1. The target number N_{T} is determined based on the predefined rail current I_{RAIL}, e.g., equal to the predefined rail current I_{RAIL} divided by a regulator current I_{VGC} that is deliverable by each voltage regulator cell 406. Additionally, in some implementations, the PMIC module 112 further includes a voltage controller 420 coupled to the array 404 of voltage regulator cells 406. The voltage controller 420 is configured to determine the target number N_{T} based on the predefined rail current I_{RAIL} associated with the first power rail 116-1, generate one or more select signals 424 based on the target number N_{T}, and provide the one or more select signals 424 to the array 404 of voltage regulator cells 406 to select the target number N_{T} of voltage regulator cells 406 (e.g., cells 406-1 and 406-2) of the first voltage regulator 116-1. In some implementations, the mapping module 414 is part of the voltage controller 420.

In some implementations, voltage regulator cells 406 in the array 404 of voltage regulator cells 406 are identical to each other. An output voltage of each voltage regulator cell 406 is determined based on a respective reference voltage V_{REF} received by the respective voltage regulator cell 406. The higher a rail current I_{RAIL} of a power rail 116, the larger the target number N_{T} of the voltage regulator cells 406 grouped to drive the power rail 116.

Conversely, in some implementations, at least two voltage regulator cells 406 in the array 404 of voltage regulator cells 406 are different from one another. For example, an output voltage of each voltage regulator cell 406 is determined based on a respective reference voltage V_{REF} received by the respective voltage regulator cell 406. The two voltage regulator cells 406 may have different driving capabilities (e.g., different regulator currents). Different numbers of the two voltage regulator cells 406 may be selected and combined based on a rail current I_{RAIL} associated with a power rail 116 and regulator currents I_{VGC} of the two voltage regulator cells 406.

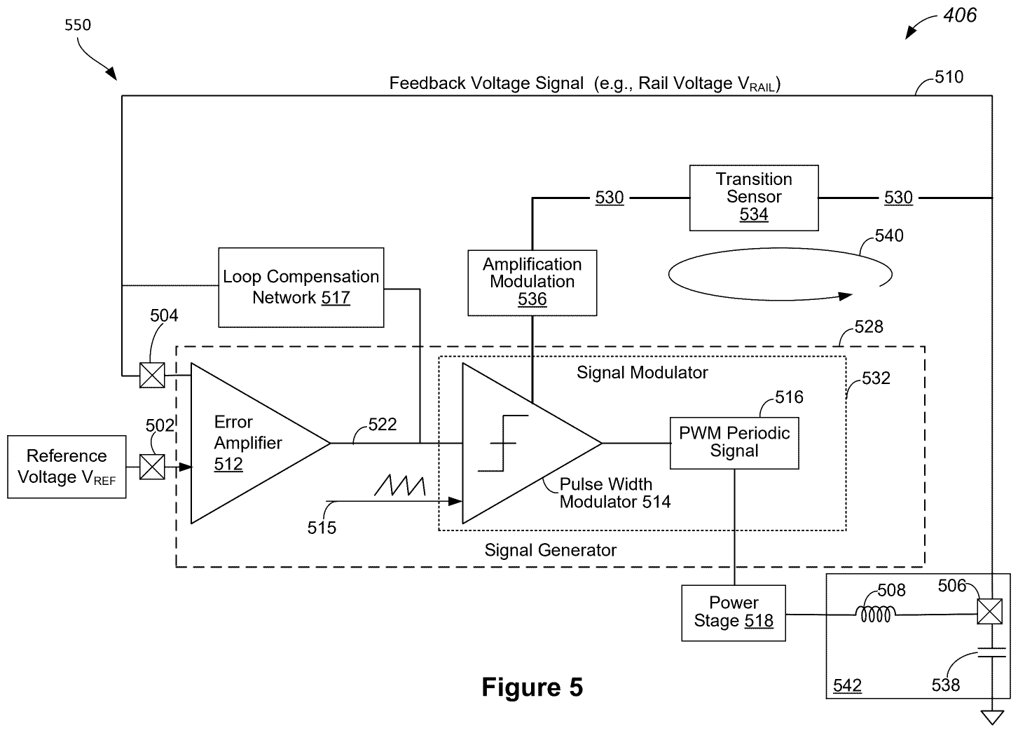

FIG. 5 is a schematic diagram of an example voltage regulator cell 406, in accordance with some implementations. In some implementations, the voltage regulator cell 406 is part of a PMIC (e.g., the PMIC module 112). In some implementations, the voltage regulator cell 406 includes an input reference interface 502 for receiving a target reference voltage V_{REF}, an input signal interface 504 for receiving an input signal (e.g., rail voltage V_{RAIL}), an output interface 506 for providing a rail voltage V_{RAIL} to a power rail (e.g., power rail 116-1 in FIG. 4B), a first feedback path 510 coupling the output interface 506 of the voltage regulator cell 406 to the input signal interface 504 of the voltage regulator cell 406, and an inductor 508 electrically coupled between the input signal interface 504 and the output interface 506.

In some embodiments, the voltage regulator cell 406 includes a plurality of voltage regulation loops that are configured to collectively and/or individually stabilize an output voltage of an electronic circuit (e.g., the electronic system 100). For example, the voltage regulator cell can include a first loop 550 that is configured to regulate the output voltage within the electronic system 100 during transient voltage conditions.

In some implementations, the first loop 550 of the voltage regulator cell 406 includes an error amplifier component (e.g., an error amplifier 512), a pulse width modulation (PWM) generation module (e.g., a pulse width modulator 514), a power stage 518, a loop compensation network 517, and a feedback signal sensing component (e.g., the feedback path 510). In some implementations, the feedback signal sensing component is configured to sense the output voltage of the electronic circuit. In some implementations, the loop compensation network 517 is configured to cause generation of a voltage compensation signal based on the voltage difference determined by the error amplifier component.

In some implementations, the first loop 550 includes a dedicated output component (e.g., the output interface 506) that is configured to transmit a voltage reference signal configured to provide a set point for a voltage regulator control scheme. In some implementations, the plurality of voltage regulation loops (e.g., the first loop 550 and the second loop 540) are configured to control the output voltage of a respective voltage regulator cell of an array of voltage regulator cells (e.g., the array 404 of voltage regulator cells 406 described with respect to FIGS. 4A and 4B).

In some implementations, the error amplifier 512 is configured to receive a reference voltage V_{REF} and a rail voltage V_{RAIL} and generate an amplified difference signal 522. In some implementations, the error amplifier 512 is configured to determine a voltage difference between the output voltage and a reference voltage. The output voltage is fed to the error amplifier component by the feedback signal sensing component. In some embodiments, the loop compensation network 517 is part of the error amplifier component (e.g., the error amplifier 512 comprises the loop compensation network 517).

The pulse width modulator 514 is coupled to the error amplifier 512 configured to generate a pulse width modulated (PWM) periodic signal 516 having a pulse width and a feature frequency f. In an example, the pulse width modulator 514 includes a comparator, and receives an input signal 515 having a Sawtooth waveform or a triangular waveform. The pulse width modulator 514 is coupled to the error amplifier 512 and configured to modulate the pulse width of the input signal 515. The power stage 518 is coupled to the pulse width modulator 514 (e.g., configured to receive a PWM signal from the PWM generation module) and configured to generate the rail voltage V_{RAIL} based on the PWM periodic signal 516.

In some implementations, the plurality of voltage regulations loops is implemented as a transistor-level design. In an example, the power stage 518 includes one or more power field effect transistors (FETs). The feedback path 510 is configured to couple an output of the power stage 518 to an input of the error amplifier 512, e.g., jointly with an LC filter (e.g., an inductor 508). In some implementations, the LC filter is configured to (i) receive a high-current PWM signal from a power stage and (ii) generate a DC voltage by filtering the high-current PWM signal.

In some implementations, the voltage regulator cell 406 includes a signal generator 528, a power stage 518, and a first feedback path 510 coupling an output of the power stage to a signal input of the signal generator 528. The signal generator 528 is configured to receive a target reference voltage V_{REF} and a rail voltage V_{RAIL} and generate a PWM periodic signal 516 having a target pulse width. The power stage 518 is coupled to the signal generator 528 and configured to generate the rail voltage based on the PWM periodic signal 516 having the target pulse width.

Further, in some implementations, the voltage regulator cell 406 includes a second loop 540 that is configured to accelerate the stabilization of an output voltage when the transient voltage conditions are being compensated for by the first loop (e.g., within a threshold time of the voltage compensation signal). That is, in the voltage regulator cell 406, a second feedback path 530 couples the output of the power stage 518 to a signal modulator 532 of the signal generator 528. The second feedback path 530 is configured to pull the rail voltage V_{RAIL} back to the target reference voltage V_{REF} when the rail voltage V_{RAIL} when it deviates from the target reference voltage V_{REF} at a deviation rate higher than a characteristic circuit rate of the voltage regulator cell 406's main regulation loop. In some embodiments, the second loop 540 is physically nested within a portion of the first loop 550.

Further, in some implementations, the second feedback path 530 further includes a transition sensor module 534 and an amplification and modulation circuit 536. The transition sensor module 534 is coupled to the output of the voltage regulation cell output 506, and configured to detect the transition in rail voltage V_{RAIL} when it deviates from the target reference voltage V_{REF} at the deviation rate. In some implementations, the transition sensor module 534 is configured to detect a voltage transient in an output voltage of the first loop.

In some implementations, the second loop 540 includes an amplification module (e.g., the amplification and modulation circuit 536). The amplification and modulation circuit 536 is coupled to the change detector 534 and the signal modulator 532, and configured to adjust a pulse width of the PWM periodic signal 516 in real-time, when the rail voltage V_{RAIL} deviates from the target reference voltage V_{REF} at the deviation rate. In other words, in some implementations, the change detector 534 is configured to sense fast voltage changes in the feedback voltage signal in the first feedback path 510 (e.g., corresponding to fast voltage changes in an output of the voltage regulator cell 406). The amplification and modulation circuit 536 may amplify the sensed voltage change, and generates a modulation signal to modulate the signal modulator 532, thereby preventing an output of the voltage regulator cell 406 from deviating from the reference voltage V_{REF}. In some embodiments, the amplification module is configured to generate a regulation-based-adjustment signal based on an output signal from the transition sensor module 534. In some embodiments, the regulation-based-adjustment signal that is generated by the amplification module is configured to bypass the loop compensation network 517.

State another way, in some implementations, the voltage regulator cell 406 is implemented based on a regulation control loop using one or more of a power stage 518, an integrated on-chip inductor 508, and a feedback voltage signal (e.g., carrying rail voltage V_{RAIL} in a first feedback path 510). The regulation control loop tracks a difference between voltage feedback signal and the selected reference voltage V_{REF}, and generates pulse width modulated signals (e.g., PWM periodic signal 516) driving the power stage 518. The output of the power stage 518 may drive an integrated on-chip inductor 508.

In some implementations, an inductor 508 and an output filter capacitor 538 forms an output filter 542. The output filter 542 may be part of, or external to, a respective voltage regulator cell 406. The output filter 542 may partially belong to a respective voltage regulator cell 406. The output filter capacitor 538 may be embedded in a GPU or CPU package substrate, a substrate of the SoC 120 (e.g., substrate 202), or a processor chip 212 (FIG. 2A). In some implementations, for a voltage regulator set 410, output terminals of on-chip inductors 508 of voltage regulator cells 406 of the voltage regulator set 410 correspond to the output interface 506, and are coupled via interconnects to an output filter capacitor 538, which may be external to the voltage regulator cells 406. Stated another way, the voltage regulator cells 406 of the voltage regulator set 410 share, and is routed separately via the interconnects to, a common output filter capacitor 538. Further, in some implementations, the feedback voltage signal carried by the feedback path 510 is connected to the output filter capacitor via the interconnects extending external to the voltage regulator cells 406.

Additionally, in some implementations, a regulation control mechanism of a voltage regulator cell 406 employs the dual control loops discussed above, including the first loop 550 (e.g., a regulation control loop) and the second loop 540 (e.g., a transient modulation loop). The regulation control loop is based on the first feedback path 510, and configured to modulate the PWM periodic signal 516 based on an error signal (e.g., amplified difference signal 522) generated by integrating a difference between the reference voltage V_{REF} and the feedback voltage signal.

In some implementations, the first loop 550 integrates a difference between the reference voltage V_{REF} and the feedback voltage signal, and includes a signal modulator 532, which is shared with the transient modulation loop 540. The amplified difference signal 522 reflects integration of the difference between the reference voltage V_{REF} and the feedback voltage signal, and is applied to modulate the PWM periodic signal 516 and generate a rail voltage V_{RAIL} to be outputted at the output interface 506 of the voltage regulator cell 406. The rail voltage V_{RAIL} settles at the associated reference voltage V_{REF}. Additionally, the transient modulation loop 540 is configured to modulate the PWM periodic signal 516 based on detection of transient characteristics of the feedback voltage signal (e.g., the rail voltage V_{RAIL}).

In accordance with some implementations, the first loop 550 is configured to, in accordance with a determination that the output voltage level fed to the error amplifier has changed, adjust the PWM from PWM generation module (e.g., to compensate for the change in the output voltage level). In some implementations, based on the change in the output voltage, the second loop 540 is configured to realize a regulation-based-adjustment signal based on the change in the output voltage.

In accordance with some implementations, the second loop 540 is only configured to provide the regulation-based-adjustment signal to drive the PWM generation module when there is a threshold amount (e.g., a detectable amount of voltage transient) caused by the first loop 550. For example, in accordance with a first determination that the transition sensor module 534 detects an adjustment to the output voltage via the first loop 550, but does not detect any voltage level in the output voltage, the second loop 540 forgoes generating the regulation-based-adjustment signal to drive the PWM generation module. And in accordance with a second determination that the transition sensor module does not detect any adjustment to the output voltage level (e.g., via the feedback path 510), but does detect a voltage transient value in the output voltage, the transition sensor module 534 is configured to generate the regulation-based-adjustment signal to drive the PWM generation module.

Some implementations of this application are directed to an electronic device, which includes a signal interface, a reference interface configured to obtain a reference voltage V_{REF}, an output interface 506 for outputting a rail voltage V_{RAIL}, a first feedback path 510 coupled between the output interface 506 and the signal interface, a difference detector (e.g., an error amplifier 512) coupled to the signal interface and the reference interface, a signal modulator 532 coupled to the difference detector, and a second feedback path 530 coupling the output interface 506 to the signal modulator 532. The difference detector is configured to detect a difference of the rail voltage V_{RAIL} and the reference voltage V_{REF}, and the signal modulator 532 is configured to compensate for the difference of the rail voltage V_{RAIL} and the reference voltage V_{REF}. The second feedback path 530 is configured to pull the rail voltage V_{RAIL} to the reference voltage V_{REF} when the rail voltage V_{RAIL} deviates from the reference voltage V_{REF} at a deviation rate higher than a characteristic circuit rate.

In some implementations, the signal modulator 532 is configured to generate a periodic signal having a pulse width. Further, in some embodiments, the electronic device includes a power stage coupled to the signal modulator 532 and configured to generate the rail voltage V_{RAIL} based on the periodic signal having the pulse width. In some embodiments, the second feedback path 530 is configured to provide a pulse width control to the signal modulator 532, and the signal modulator 532 is configured to modulate an input signal having a periodic waveform to generate the period signal having the pulse width.

In some implementations, the second feedback path 530 further includes a change detector 534 coupled to the output interface 506 and an amplification and modulation circuit 536 coupled to the change detector 534 and the signal modulator 532. The change detector 534 is configured to detect the rail voltage V_{RAIL} deviating from the reference voltage V_{REF} at the deviation rate. The amplification and modulation circuit 536 is configured to adjust the pulse width of the periodic signal in real time, when the rail voltage V_{RAIL} deviates from the reference voltage V_{REF} at the deviation rate. Further, in some implementations, the change detector 534 is configured to detect an overshoot or an undershoot of the rail voltage V_{RAIL} at the deviation rate. In some implementations, the amplification and modulation circuit 536 is configured to bypass the difference detector and control the signal modulator 532 directly. In some implementations, the deviation rate is programmable, and the change detector 534 is configured to program the deviation rate. In some implementations, the amplification and modulation circuit 536 has a programmable gain.

In some embodiments, the electronic device further includes an output filter 542 coupled to the output interface 506, wherein the output filter 542 further includes an integrated inductor 508 electrically coupled to the output interface 506 and is configured to control noise of the rail voltage V_{RAIL}.

In some implementations, the difference detector includes an error amplifier 512 configured to receive the reference voltage V_{REF} and the rail voltage V_{RAIL} and generate an amplified difference signal 522 indicating the difference of the rail voltage V_{RAIL} and the reference voltage V_{REF}.

In some implementations, a first loop 550 is formed based on at least the difference detector, the signal modulator 532, and the first feedback path 510, and configured to define the characteristic circuit rate. In some implementations, a second loop 540 is formed based on at least the signal modulator 532 and the first feedback path 510. The second loop 540 is a nested fast loop applied to boost up a transient response of the first loop 550, which acts as a primary PMIC voltage regulation loop. In some embodiments, the nested fast loop may be a linear loop that bypasses the error amplifier 512 and the loop compensation network 517 of the first loop 550, thereby reacting instantly to stabilize the rail voltage V_{RAIL} outputted by the voltage regulator cell. Stated another way, the second loop 540 operates based on derivative control, e.g., by sensing a variation of the rail voltage V_{RAIL} and reacting in an opposite direction of the variation, and helps control an overshoot or an undershoot of the rail voltage V_{RAIL} without causing circuit oscillation.

In some implementations, the electronic device further includes an array 404 of voltage regulator cells including a first voltage regulator. The signal interface 504, the reference interface 502, the output interface 506, the first feedback path 510, the difference detector, the signal modulator 532 and the second feedback path 530 form the first voltage regulator. Further, in some implementations, the electronic device further includes a processor coupled to the array of voltage regulator cells, the processor further including a power rail configured to receive the rail voltage V_{RAIL} provided by a subset of voltage regulator cells including the first voltage regulator.

Some implementations of this application include a voltage regulator cell 406 further including two regulation loops (e.g., a first loop 550 and a second loop 540). The first loop 550 includes a feedback path 510, a voltage reference signal V_{REF}, an error amplifier 512 with a loop compensation network 517, a PWM modulator 514, a power stage 518, and an output filter 542. The feedback path 510 feeds the rail voltage outputted by the voltage regulator cell 406 to the error amplifier 512. The voltage reference signal V_{REF} provides a setpoint of the rail voltage. The error amplifier senses a voltage level difference between an input voltage fed at the input interface 504 and the reference voltage V_{REF}, and the voltage level difference is filtered by the compensation network 517 and applied to generate an error signal 522 to drive PWM generation. An input signal 515 is modulated by the error signal 522 to generate the PWM periodic signal 516 that drives the power stage 518. The power stage 518 drives the PWM periodic signal 516 to the output filter 542. A DC rail voltage is generated by the output filter 542 filtering a high current component out of the power stage 518. The second loop 540 is a nested linear loop within the first loop 550. It includes a transition sensor module 534 and an amplification and modulation circuit 538. The transition sensor module 534 detects the voltage transient in the rail voltage generated by the voltage regulator cell 406. The rail voltage is fed into the second loop's transition sensor module 534. The output signal from the transition sensor module and drives amplification and modulation module 536 that generates the needed adjustment signal to drive the pulse width modulator 514.

In some embodiments, the first loop 550 is configured to respond to voltage level changes in the rail voltage by adjusting the PWM periodic signal 516, and the second loop 540 realizes augmented PWM signal adjustment based on a transition in the rail voltage outputted by the voltage regulator cell 406. In some embodiments, the second loop 540 is configured to react to a voltage transition, and is substantially insensitive to a voltage level of the regulator's output. In some embodiments, the transition sensor module 534 may sense the output transition of the rail voltage, enabling the second loop 540 to stabilize the rail voltage in both overshoot and undershoot directions without causing any oscillation. In some embodiments, the amplification and modulation module 536 boosts the sensed transition signal and instantly modulate the PWM periodic signal 516. In some embodiments, the second feedback path 530 bypasses the compensation network 517 and directly modulates the pulse width modulator 514. In some embodiments, both the transition sensor module 534 and the amplification and modulation module 536 are customized for different customer application cases.

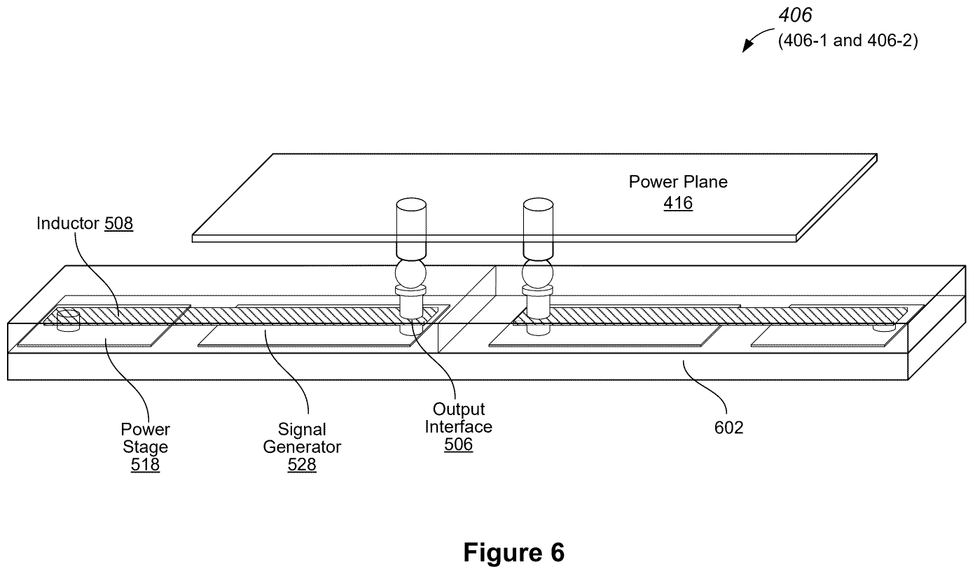

FIG. 6 is a conceptual diagram illustrating example two voltage regulator cells 406-1 and 406-2 (also shown in FIG. 4B) for providing a rail voltage V_{RAIL}, in accordance with some implementations. Each of the two voltage regulator cells 406-1 and 406-2 includes a respective inductor 508 electrically coupled to an output interface 506 of the respective voltage regulator cell 406. In some implementations, for each voltage regulator cell 406-1 or 406-2, the respective inductor 508 is integrated on chip, e.g., monolithically formed on a respective PMIC chip 204. In some implementations, a configurable power plane 416 is embedded in a module substrate of a PMIC module 112 or a substrate 202 of the SoC 120 to which a PMIC module 112 is mounted. The two voltage regulator cells 406-1 and 406-2 may be formed on a common chip substrate 602 or on two distinct chip substrates 602. The output interfaces 506 of the two voltage regulator cells 406-1 and 406-2 are electrically coupled to the power plane 416, which is further coupled to a power rail 116 (not shown on FIG. 6).

In some implementations, the inductor 508 is integrated on the cell substrate 602, e.g., above the signal generator 528, the power stage 518, and/or any other circuits 408, 412, 418, or 420 of the PMIC module 112. An input terminal of the inductor 508 is coupled to an output of the power stage 518, e.g., using a via, a metallic layer, a solder ball, a redistribution layer (RDL), or a combination thereof. In an example, an output terminal of the inductor 508 corresponds to an output of the inductor 508, and is connected to an interconnect that couples the inductor 508 to a bump or a solder ball of the PMIC module 112. The bump or solder ball is applied to electrically couple the PMIC module 112 to other electrical components (e.g., components 102-108) of an SoC 120. In some implementations, each of two terminals of the inductor 508 includes a respective interconnect made of a via, a metallic layer, an RDL, or a combination thereof, and is configured to provide a Kelvin sensing point.

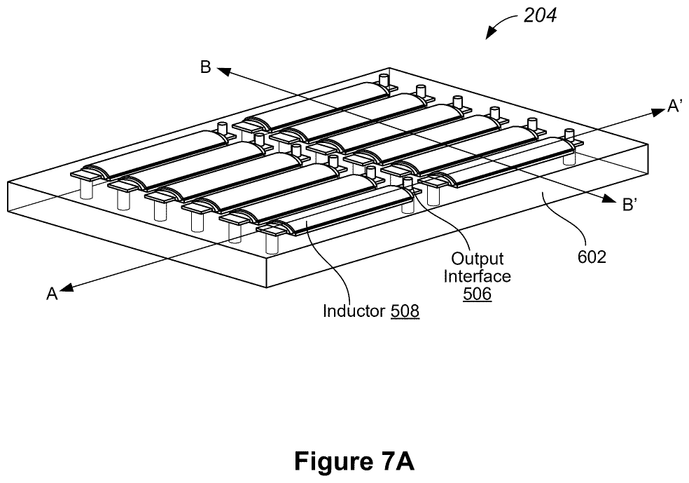

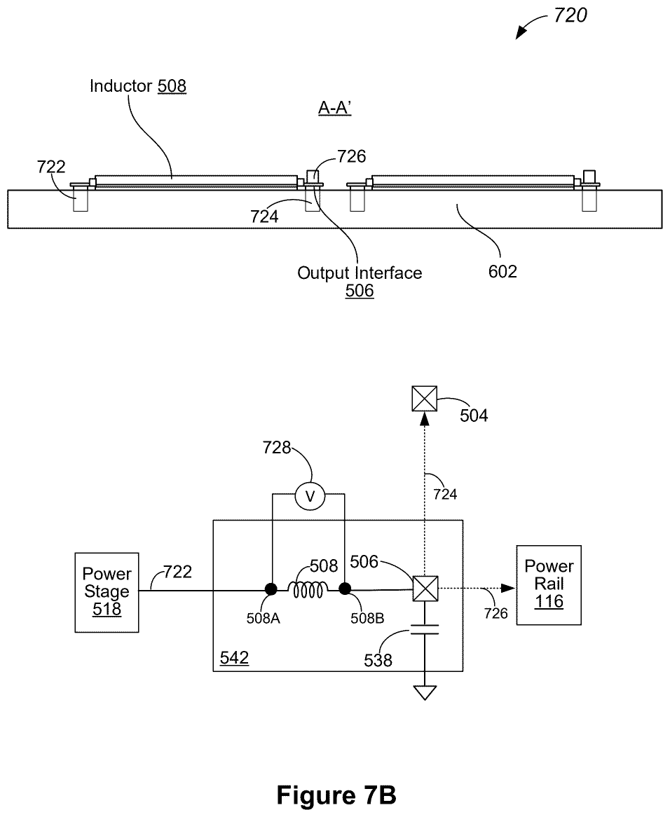

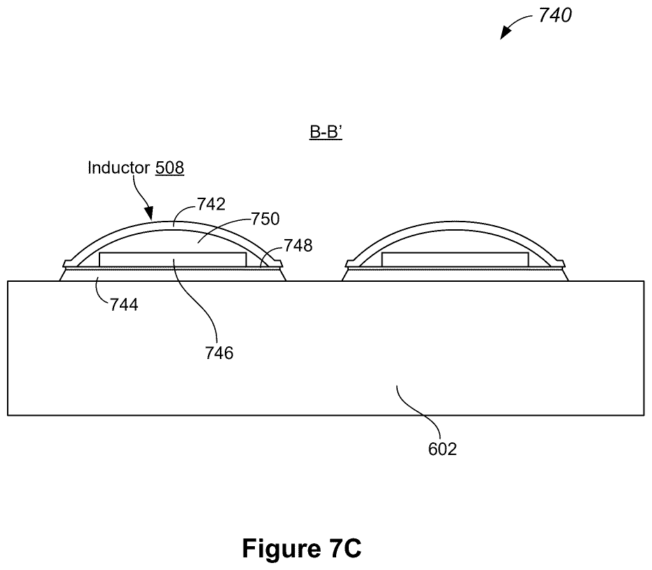

FIG. 7A is a perspective view of an example PMIC chip 204 including a plurality of inductors 508 coupled in a plurality of voltage regulator cells 406, in accordance with some implementations, and FIGS. 7B and 7C are two cross sectional views 720 and 740 of a portion of the PMIC chip 204 shown in FIG. 7A including two inductors 508 of two voltage regulator cells 406, in accordance with some implementations. The PMIC chip 204 has a chip substrate 602 and includes twelve voltage regulator cells 406 formed monolithically on a top surface of the chip substrate 602. Each voltage regulator cell 406 includes a respective inductor 508 integrated on the top surface of the chip substrate 602. Stated another way, the voltage regulator cells 406 (e.g., transistors and metal interconnects) may be formed on the cell substrate 602 and partially underneath the inductor 508. The PMIC chip 204 includes two cross sections AA′ and BB′ that are perpendicular to one another and to the top surface of the chip substrate 602. The cross section AA′ is shown in FIG. 7B, and part of the cross section BB′ is shown in FIG. 7C.

Referring to FIG. 7B, in some implementations, an inductor 508 includes three vias 722, 724, and 726. A first via 722 is coupled between an output a power stage 518) of a respective voltage regulator cell 406 to an input terminal 508A of the inductor 508, driving current toward the inductor 508. In some implementations, a second via 724 is coupled between an output terminal 508B of the respective inductor 508. The output terminal 508B of the respective inductor 508 corresponds to an output port 506 of the voltage regulator cell 406. Alternatively, in some implementations, the second via 724 is coupled between the output terminal 508B of the respective inductor 508 and an input signal interface 504 (FIG. 5). A third via 726 is coupled between the output terminal 508B of the inductor 508 and a power rail 116 powering other components (e.g., components 102-108 in FIG. 1) of an SoC 120, providing current and power to enable operations of the other components of the SoC 120. In some implementations, the third via 726 couples the output terminal 508B of the inductor 508 to the power rail 116 via a configurable power plane 416 (FIG. 6). In some implementations, the third via 726 is vertically aligned with the second via 724. In some implementations not shown, the third via 726 is laterally shifted (i.e., not vertically aligned) with respect to the second via 724.

In some embodiments, the first via 722 and the second via 724 enable Kelvin connections for sensing a current passing a conduction trace of the inductor 508. A current sensing circuit 728 is coupled to the input terminals 508A and the output terminal 508B of the inductor 508, and configured to measure a voltage drop on the inductor 508. Given that a resistance of the inductor 508 is known, the voltage drop is applied to determine a current passing through the inductor 508.

In some implementations, each of two terminals 508A and 508B of the inductor 508 includes a respective interconnect made of a via, a metallic layer, an RDL, or a combination thereof. The respective interconnect forms a Kelvin connection, which may be coupled to a current sensing circuit associated with the voltage regulator cell 406 for sensing an inductor current running through the inductor 508. In some implementations, a distance between Kelvin connections of each voltage regulator cell 406 is substantially uniform in the array 404 of voltage regulator cells 406 (e.g., in FIG. 7A). For each voltage regulator set 410, current balancing among different voltage regulator cells 406 is enabled using a single shared reference circuit 408.

Referring to FIG. 7C, in some implementations, the inductor 508 is formed on top of the cell substrate 602 (e.g. a silicon substrate), and include at least two laminated magnetic thin film layers 742 and 744 wrapping around a conductor 746. The inductor 508 further includes an insulation film layer 748 and a dielectric filling structure 750. The two laminated magnetic thin film layers 742 and 744 are electrically isolated from the conductor 746 by the insulation film layer 748 and a dielectric filling structure 750. In some implementations, there is no gap in an enclosure formed by the two laminated magnetic thin film layers 742 and 744. Conversely, in some implementations, there is a gap in the enclosure formed by the two laminated magnetic thin film layers 742 and 744. Further, in some implementations, each of the two laminated magnetic thin film layers 742 and 744 includes a stack of alternating magnetic thin films and dielectric thin films.

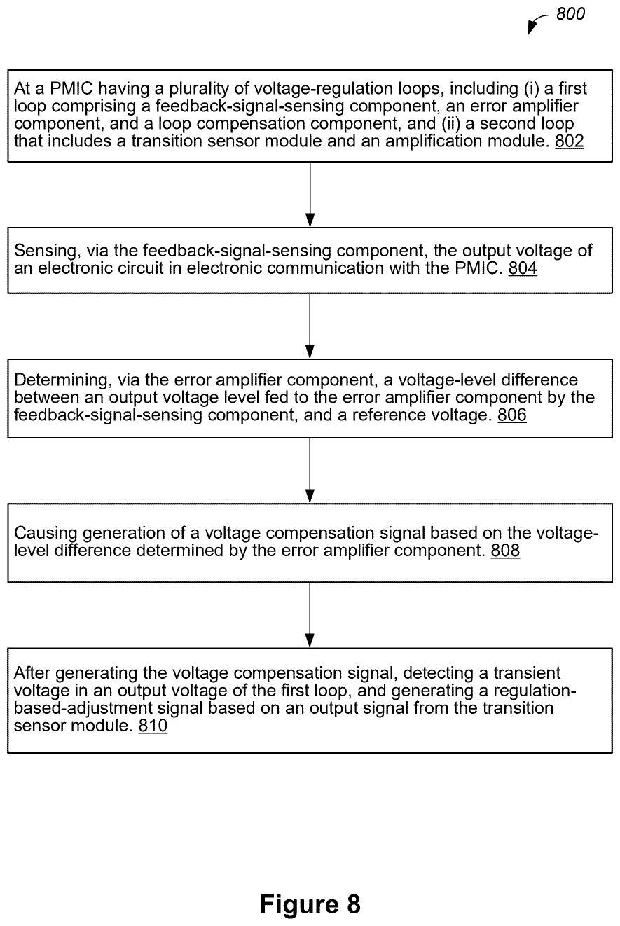

FIG. 8 is a flow diagram of an example method for stabilizing an output voltage, in accordance with some implementations. The method 800 is implemented at a PMIC (e.g., the PMIC 112) having a plurality of voltage regulation loops, including a first loop comprising a feedback signal sensing component (e.g., the feedback signal sensing component 510), an error amplifier component (e.g., the error amplifier 512), and a loop compensation component (e.g., the first loop 550 shown in FIG. 5); and a second loop that includes a transition sensor module and an amplification module (operation 802).

In some implementations of the method 800, the PMIC 112 senses (operation 804), via the feedback signal sensing component, an output voltage of an electronic circuit in electronic communication with the PMIC.

In some implementations of the method 800, the PMIC 112 determines (806), via the error amplifier component, a voltage difference between the output voltage fed to the error amplifier component by the feedback signal sensing component, and a reference voltage.

In some implementations of the method 800, the PMIC 112 causes (808) generation of a voltage compensation signal based on the voltage difference determined by the error amplifier component.

In some implementations of the method 800, after generating the voltage compensation signal, the PMIC 112 detects a transient voltage in an output voltage of the first loop, and generating a regulation-based-adjustment signal based on an output signal from the transition sensor module (810).

Each of the above identified elements may be stored in one or more memory devices, and corresponds to a set of instructions for performing a function described above. The above identified modules or programs (i.e., sets of instructions) need not be implemented as separate software or firmware programs, procedures, modules or data structures, and thus various subsets of these modules may be combined or otherwise re-arranged in various implementations. In some implementations, the memory, optionally, stores a subset of the modules and data structures identified above. Furthermore, the memory, optionally, stores additional modules and data structures not described above.

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An electronic system, comprising: a first loop configured to regulate the output voltage within the electronic circuit during transient voltage conditions, comprising: a feedback signal sensing component configured to sense the output voltage of the electronic circuit; an error amplifier component configured to determine a voltage difference between (i) the output voltage fed to the error amplifier component by the feedback signal sensing component, and (ii) a reference voltage; and a loop compensation network configured to cause generation of a voltage compensation signal based on the voltage difference determined by the error amplifier component; and a second loop configured to accelerate the stabilization of output voltage while the transient voltage conditions are being compensated for by the first loop, the second loop comprising: a transition sensor module configured to detect a voltage transient in an/the output voltage of the first loop; and an amplification module configured to generate a regulation-based-adjustment signal based on an output signal from the transition sensor module.

Clause 2. The electronic system of clause 1, further comprising: a pulse width modulation (PWM) generation module; and a power stage configured to receive a PWM signal from the PWM generation module.

Clause 3. The electronic system of clause 2, wherein the regulation-based-adjustment signal is used to drive the PWM generation module.

Clause 4. The electronic system of clause 3, wherein: the first loop is configured to, in accordance with a determination that the output voltage level fed to the error amplifier component has changed, adjusting the PWM from the PWM generation module, and the second loop realizes the regulation-based-adjustment signal based on the change in the output voltage.

Clause 5. The electronic system of clause 3 or clause 4, wherein: in accordance with a first determination that the transition sensor module detects an adjustment to the output voltage via the first loop, but does not detecting any voltage level in the output voltage: forgoing generating the regulation-based-adjustment signal to drive the PWM generation module, and in accordance with a second determination that the transition sensor module does not detect any adjustment to the output voltage level, but does detect a voltage transient value in the output voltage: generating the regulation-based-adjustment signal to drive the PWM generation module.

Clause 6. The electronic system of any one of clause 1 to clause 5, wherein the plurality of voltage regulation loops is implemented as a transistor-level design.

Clause 7. The electronic system of any one of clause 1 to clause 6, further comprising: an LC filter configured to (i) receive a high-current PWM signal from a power stage and (ii) generate a DC voltage by filtering the high-current PWM signal.

Clause 8. The electronic system of any one of clause 1 to clause 7, wherein the regulation-based-adjustment signal bypasses the loop compensation network.

Clause 9. The electronic system of any one of clause 1 to clause 8, wherein the first loop further includes a dedicated output component configured to transmit a voltage reference signal configured to provide a setpoint for a voltage regulator control scheme.

Clause 10. The electronic system of any one of clause 1 to clause 9, wherein the loop compensation network is part of the error amplifier component.

Clause 11. The electronic system of any one of clause 1 to clause 10, wherein the second loop is physically nested within a portion of the first loop.

Clause 12. The electronic system of any one of clause 1 to clause 11, wherein the plurality of voltage regulation loops is configured to control the output voltage of a respective voltage regulator cell of an array of voltage regulator cells.

Clause 13. A power management integrated circuit (PMIC), comprising: a plurality of voltage regulation loops configured to stabilize an output voltage, including: a first loop configured to regulate voltage within an electronic circuit during transient voltage conditions, comprising: a feedback signal sensing component configured to sense the output voltage of the electronic circuit; an error amplifier component, the error amplifier component configured to determine a voltage difference between (i) the output voltage fed to the error amplifier component by the feedback signal sensing component, and (ii) a reference voltage; and a loop compensation network configured to cause generation of a voltage-compensation signal based on the voltage difference determined by the error amplifier component; and a second loop configured to accelerate the stabilization of output voltage while the transient voltage conditions is being compensated for by the first loop, the second loop comprising: a transition sensor module configured to detect a voltage transient in the output voltage of the first loop; and an amplification module configured to generate a regulation-based-adjustment signal based on an output signal from the transition sensor module.

Clause 14. The PMIC of clause 13, wherein the plurality of voltage regulation loops configured to stabilize an output voltage further includes: a pulse width modulation (PWM) generation module; and a power stage configured to receive a PWM signal from the PWM generation module.

Clause 15. The PMIC of clause 14, wherein the regulation-based-adjustment signal is used to drive the PWM generation module.

Clause 16. The PMIC of clause 15, wherein: the first loop is configured to, in accordance with a determination that the output voltage level fed to the error amplifier component has changed, adjusting the PWM from the PWM generation module, and the second loop realizes the regulation-based-adjustment signal based on the change in the output voltage.

Clause 17. The PMIC of clause 15 or clause 16, wherein: in accordance with a first determination that the transition sensor module detects an adjustment to the output voltage via the first loop, but does not detecting any voltage level in the output voltage: forgoing generating the regulation-based-adjustment signal to drive the PWM generation module, and in accordance with a second determination that the transition sensor module does not detect any adjustment to the output voltage level, but does detect a voltage transient value in the output voltage: generating the regulation-based-adjustment signal to drive the PWM generation module.

Clause 18. The PMIC of any one of clause 13 to clause 17, wherein the plurality of voltage regulation loops is implemented as a transistor-level design.

Clause 19. The PMIC of any one of clause 13 to clause 18, further comprising: an LC filter configured to (i) receive a high-current PWM signal from a power stage and (ii) generate a DC voltage by filtering the high-current PWM signal.

Clause 20. A method of stabilizing an output voltage, comprising: at a PMIC having a plurality of voltage regulation loops, including (i) a first loop comprising a feedback signal sensing component, an error amplifier component, and a loop compensation component, and (ii) a second loop that includes a transition sensor module and an amplification module: sensing, via the feedback signal sensing component, the output voltage of an electronic circuit in electronic communication with the PMIC; determining, via the error amplifier component, a voltage difference between the output voltage fed to the error amplifier component by the feedback signal sensing component, and a reference voltage; causing generation of a voltage compensation signal based on the voltage difference determined by the error amplifier component; and after generating the voltage compensation signal: detecting a transient voltage in an/the output voltage of the first loop the output voltage of the first loop; and generating a regulation-based-adjustment signal based on an output signal from the transition sensor module.

Clause 21. An electronic device, comprising: a signal interface; a reference interface configured to obtain a reference voltage; an output interface for outputting a rail voltage; a first feedback path coupled between the output interface and the signal interface; a difference detector coupled to the signal interface and the reference interface, the difference detector configured to detect a difference of the rail voltage and the reference voltage; a signal modulator coupled to the difference detector, the signal modulator configured to compensate for the difference of the rail voltage and the reference voltage; and a second feedback path coupling the output interface to the signal modulator, the second feedback path configured to pull the rail voltage to the reference voltage when the rail voltage deviates from the reference voltage at a deviation rate higher than a characteristic circuit rate.

Clause 22. The electronic device of clause 21, wherein the signal modulator is configured to generate a periodic signal having a pulse width.

Clause 23. The electronic device of clause 22, further comprising: a power stage coupled to the signal modulator and configured to generate the rail voltage based on the periodic signal having the pulse width.

Clause 24. The electronic device of clause 22 or 23, wherein the second feedback path is configured to provide a pulse width control to the signal modulator, and the signal modulator is configured to modulate an input signal having a periodic waveform to generate the period signal having the pulse width.

Clause 25. The electronic device of any of clauses 22-24, wherein the second feedback path further comprises: a change detector coupled to the output interface, the change detector configured to detect the rail voltage deviating from the reference voltage at the deviation rate; and an amplification and modulation circuit coupled to the change detector and the signal modulator, the amplification and modulation circuit configured to adjust the pulse width of the periodic signal in real time, when the rail voltage deviates from the reference voltage at the deviation rate.

Clause 26. The electronic device of clause 25, wherein the change detector is configured to detect an overshoot or an undershoot of the rail voltage at the deviation rate.

Clause 27. The electronic device of clause 25 or 26, wherein the amplification and modulation circuit is configured to bypass the difference detector and control the signal modulator directly.

Clause 28. The electronic device of any of clauses 25-27, wherein the deviation rate is programmable, and the change detector is configured to program the deviation rate.

Clause 29. The electronic device of any of clauses 25-28, wherein the amplification and modulation circuit has a programmable gain.

Clause 30. The electronic device of any of clauses 21-29, further comprising an output filter coupled to the output interface, wherein the output filter further includes an integrated inductor electrically coupled to the output interface and is configured to control noise of the rail voltage.

Clause 31. The electronic device of any of clauses 21-30, wherein the difference detector includes an error amplifier configured to receive the reference voltage and the rail voltage and generate an amplified difference signal indicating the difference of the rail voltage and the reference voltage.

Clause 32. The electronic device of any of clauses 21-31, wherein a first loop is formed based on at least the difference detector, the signal modulator, and the first feedback path, and configured to define the characteristic circuit rate.

Clause 33. The electronic device of any of clauses 21-32, wherein a second loop is formed based on at least the signal modulator and the first feedback path.

Clause 34. The electronic device of any of clauses 21-33, further comprising an array of voltage regulator cells including a first voltage regulator, wherein the signal interface, the reference interface, the output interface, the first feedback path, the difference detector, the signal modulator and the second feedback path form the first voltage regulator.

Clause 35. The electronic device of clause 24, further comprising a processor coupled to the array of voltage regulator cells, the processor further including a power rail configured to receive the rail voltage provided by a subset of voltage regulator cells including the first voltage regulator.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if”' is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. An electronic system, comprising:
a plurality of voltage regulation loops configured to stabilize an output voltage of an electronic circuit, including:
a first loop configured to regulate the output voltage within the electronic circuit during transient voltage conditions, comprising:
a feedback path configured to sense the output voltage of the electronic circuit;
an error amplifier component configured to determine a voltage difference between (i) the output voltage fed to the error amplifier component by the feedback path, and (ii) a reference voltage; and
a loop compensation network configured to cause generation of a voltage compensation signal based on the voltage difference determined by the error amplifier component; and
a second loop configured to accelerate the stabilization of an output voltage when the transient voltage conditions is being compensated for by the first loop, the second loop comprising:
a transition sensor module configured to detect a voltage transient in an output voltage of the first loop; and
an amplification module configured to generate a regulation-based-adjustment signal based on an output signal from the transition sensor module.

2. The electronic system of claim 1, further comprising:
a pulse width modulation (PWM) generation module; and
a power stage configured to receive a PWM signal from the PWM generation module.

3. The electronic system of claim 2, wherein the regulation-based-adjustment signal is used to drive the PWM generation module.

4. The electronic system of claim 3, wherein:
the first loop is configured to, in accordance with a determination that the output voltage level fed to the error amplifier component has changed, adjusting the PWM from the PWM generation module, and
the second loop realizes the regulation-based-adjustment signal based on the change in the output voltage.

5. The electronic system of claim 3, wherein:
in accordance with a first determination that the transition sensor module detects an adjustment to the output voltage via the first loop, but does not detecting any voltage level adjustment in the output voltage:
forgoing generating the regulation-based-adjustment signal to drive the PWM generation module, and
in accordance with a second determination that the transition sensor module does not detect any adjustment to the output voltage level, but does detect a voltage transient value in the output voltage:
generating the regulation-based-adjustment signal to drive the PWM generation module.

6. The electronic system of claim 1, wherein the plurality of voltage regulation loops is implemented as a transistor-level design.

7. The electronic system of claim 1, further comprising:
an LC filter configured to (i) receive a high-current PWM signal from a power stage and (ii) generate a DC voltage by filtering the high-current PWM signal.

8. The electronic system of claim 1, wherein the regulation-based-adjustment signal bypasses the loop compensation network.

9. The electronic system of claim 1, wherein the first loop further includes a dedicated output component configured to transmit a voltage reference signal configured to provide a setpoint for a voltage regulator control scheme.

10. The electronic system of claim 1, wherein the loop compensation network is part of the error amplifier component.

11. The electronic system of claim 1, wherein the second loop is physically nested within a portion of the first loop.

12. The electronic system of claim 1, wherein the plurality of voltage regulation loops is configured to control the output voltage of a respective voltage regulator cell of an array of voltage regulator cells.

13. A power management integrated circuit (PMIC), comprising:
a plurality of voltage regulation loops configured to stabilize an output voltage, including:
a first loop configured to regulate voltage within an electronic circuit during transient voltage conditions, comprising:
a feedback path configured to sense the output voltage of the electronic circuit;
an error amplifier component, the error amplifier component configured to determine a voltage difference between (i) the output voltage fed to the error amplifier component by the feedback path, and (ii) a reference voltage; and
a loop compensation network configured to cause generation of a voltage-compensation signal based on the voltage difference determined by the error amplifier component; and
a second loop configured to stabilize output voltage after the transient voltage conditions have been compensated for by the first loop, the second loop comprising:
a transition sensor module configured to detect a transient voltage in the output voltage of the first loop; and
an amplification module configured to generate a regulation-based-adjustment signal based on an output signal from the transition sensor module.

14. The PMIC of claim 13, wherein the plurality of voltage regulation loops configured to stabilize an output voltage further includes:
a pulse width modulation (PWM) generation module; and
a power stage configured to receive a PWM signal from the PWM generation module.

15. The PMIC of claim 14, wherein the regulation-based-adjustment signal is used to drive the PWM generation module.

16. The PMIC of claim 15, wherein:
the first loop is configured to, in accordance with a determination that the output voltage level fed to the error amplifier component has changed, adjusting the PWM from the PWM generation module, and
the second loop realizes the regulation-based-adjustment signal based on the change in the output voltage.

17. The PMIC of claim 15, wherein:
in accordance with a first determination that the transition sensor module detects an adjustment to the output voltage via the first loop, but does not detecting any voltage level adjustment in the output voltage:
forgoing generating the regulation-based-adjustment signal to drive the PWM generation module, and
in accordance with a second determination that the transition sensor module does not detect any adjustment to the output voltage level, but does detect a voltage transient value in the output voltage:
generating the regulation-based-adjustment signal to drive the PWM generation module.

18. The PMIC of claim 13, wherein the plurality of voltage regulation loops is implemented as a transistor-level design.

19. The PMIC of claim 13, further comprising:
an LC filter configured to (i) receive a high-current PWM signal from a power stage and (ii) generate a DC voltage by filtering the high-current PWM signal.

20. A method of stabilizing an output voltage, comprising:
at a PMIC including (i) a first loop comprising a feedback path, an error amplifier component, and a loop compensation component, and (ii) a second loop that includes a transition sensor module and an amplification module:
sensing, via the feedback path, the output voltage of an electronic circuit in electronic communication with the PMIC;
determining, via the error amplifier component, a voltage difference between the output voltage fed to the error amplifier component by the feedback path, and a reference voltage;
causing generation of a voltage compensation signal based on the voltage difference determined by the error amplifier component; and
after generating the voltage compensation signal:
detecting a voltage transient in an/the output voltage of the first loop the output voltage of the first loop; and
generating a regulation-based-adjustment signal based on an output signal from the transition sensor module.
